(19) United States
(12) Patent Application Publication
(10) Pub. No.: US 2026/0219226 A1
(43) Pub. Date: Jul. 30, 2026

(54) CATALYST INK TEST METHOD AND CATALYST INK TEST SYSTEM

(71) Applicant: HONDA MOTOR CO., LTD., Tokyo (JP)

(72) Inventors: Hiroshi Matsumori, Wako-shi (JP); Takanori Maebashi, Wako-shi (JP); Ryosuke Inoue, Wako-shi (JP)

(21) Appl. No.: 19/449,488

(22) Filed: Jan. 15, 2026

(30) Foreign Application Priority Data
Jan. 27, 2025 (JP) 2025-011213

(51) Int. Cl. G01N 27/22; G01N 27/12

(52) U.S. Cl. CPC G01N 27/227; G01N 27/12

(57) ABSTRACT

A catalyst ink test system includes a sample acquisition part, an impedance analysis device, and a processing device. The sample acquisition part collects a test sample from the catalyst ink. The impedance analysis device measures impedance of the sample. Based on impedance measurement data, the impedance analysis device generates a Cole-Cole plot corresponding to a preset equivalent circuit. The processing device acquires a resonance frequency of the sample based on the Cole-Cole plot. The processing device acquires an amount of foreign matter in the sample, which changes toward an increasing trend, when the resonance frequency of the sample is lower than a reference resonance frequency.

### CROSS-REFERENCE TO RELATED APPLICATION

Priority is claimed on Japanese Patent Application No. 2025-011213, filed January 27, 2025, the content of which is incorporated herein by reference.

### BACKGROUND OF THE INVENTION

### Field of the Invention

The present invention relates to a catalyst ink test method and a catalyst ink test system.

### Description of Related Art

In recent years, research and development efforts have focused on fuel cells that improve energy efficiency, with the aim of providing more people with access to affordable, reliable, sustainable, and advanced energy.

Conventionally, in a method for manufacturing an electrode membrane for a fuel cell in which a catalyst ink is applied onto a transfer sheet and a catalyst layer formed by drying the catalyst ink is transferred onto an electrolyte membrane, a method in which a defect such as foreign matter detected in the catalyst layer is removed by laser irradiation and the catalyst layer is then repaired is known (see, for example, PCT International Publication No. WO/2016/125240).

### SUMMARY OF THE INVENTION

In the field of fuel cell technology, an issue is to suppress the complexity of the manufacturing process and the increase in manufacturing costs. For example, as in the above-described conventional technology, when a laser device having a microscopic function is used to detect and remove a defect such as foreign matter in the catalyst layer, the cost required for the device configuration increases, and there is a risk that the manufacturing process becomes complicated due to rework and the like.

Moreover, to address such problems, for the purpose of detecting foreign matter contamination in a state of the catalyst ink prior to a coating process, for example, a method using a fluorescent X-ray analysis device, an inductively coupled plasma (ICP) analysis device, and the like is known. However, when such special devices are used, because the preparation, including pretreatment and placement of the analysis target sample and the like, requires considerable time and complicated operations, it is difficult to reduce the number of processes.

An aspect of the present application achieves speeding up of the manufacturing process and reduction of costs. An aspect of the present application contributes to improving energy efficiency.

The present invention adopts the following aspects.

(1): According to an aspect of the present invention, there is provided a catalyst ink test method including: a sample acquisition step of acquiring a test target sample from catalyst ink for forming a catalyst layer laminated on at least one of an electrolyte membrane and a gas diffusion layer; an impedance acquisition step of acquiring impedance of the sample; and a processing step of detecting foreign matter mixed into the catalyst ink based on a resonance frequency corresponding to the impedance.

(2): In the catalyst ink test method according to the above-described (1), the processing step may include determining that the foreign matter is contained in the catalyst ink when the resonance frequency is less than a predetermined reference value.

(3): In the catalyst ink test method according to the above-described (2), the processing step may include determining that an amount of foreign matter contained in the catalyst ink changes toward an increasing trend when the resonance frequency is less than the predetermined reference value.

(4): In the catalyst ink test method according to the above-described (2) or (3), the predetermined reference value may be the resonance frequency of a case where no foreign matter is contained in the catalyst ink.

(5): According to an aspect of the present invention, there is provided a catalyst ink test system including: a sample acquisition part configured to acquire a test target sample from catalyst ink for forming a catalyst layer laminated on at least one of an electrolyte membrane and a gas diffusion layer; an impedance acquisition part configured to acquire impedance of the sample; and a processing unit configured to detect foreign matter mixed into the catalyst ink based on a resonance frequency corresponding to the impedance.

According to the above-described aspect (1), it is possible to detect the presence or absence of foreign matter mixed into the catalyst ink in a process step before the catalyst layer is formed, based on the impedance of the sample. For example, compared with when the presence or absence of foreign matter is detected using a fluorescent X-ray analysis device, an ICP analysis device, or the like, it is possible to contribute to speeding up the manufacturing process and reducing costs.

In the case of the above-described aspect (2), by determining whether or not the resonance frequency is less than the predetermined reference value, it is possible to easily determine the presence or absence of the foreign matter mixed into the catalyst ink.

In the case of the above-described aspect (3), it is possible to easily detect the amount of foreign matter mixed into the catalyst ink in accordance with the difference between the resonance frequency and the predetermined reference value.

In the case of the above-described aspect (4), it is possible to easily detect the presence or absence and the amount of foreign matter mixed into the catalyst ink.

According to the above-described aspect (5), it is possible to detect the presence or absence of the foreign matter mixed into the catalyst ink in a process step before the catalyst layer is formed, based on the impedance of the sample. For example, compared with when the presence or absence of the foreign matter is detected using a fluorescent X-ray analysis device or an ICP analysis device, it is possible to contribute to speeding up the manufacturing process and reducing costs.

### BRIEF DESCRIPTION OF THE DRAWINGS

FIG. 1 is a configuration diagram of a catalyst ink test system of an embodiment of the present invention.

FIG. 2 is a diagram showing an example of a Cole-Cole plot obtained by a catalyst ink test system of the embodiment of the present invention.

FIG. 3 is a flowchart showing an operation of the catalyst ink test system in a manufacturing process of various types of electrodes for fuel cells according to the embodiment of the present invention.

### DETAILED DESCRIPTION OF THE INVENTION

Hereinafter, a catalyst ink test system and a catalyst ink test method according to embodiments of the present invention will be described with reference to the accompanying drawings.

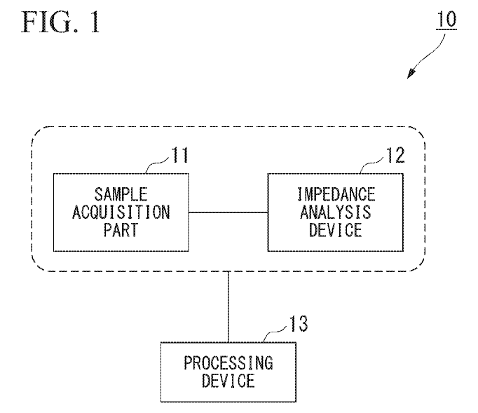

FIG. 1 is a configuration diagram of a catalyst ink test system 10 according to the embodiment. The catalyst ink test system 10 of the embodiment is used, for example, for inline testing, offline testing, full testing, or sampling testing of catalyst ink and the like in a manufacturing line of various types of electrodes for fuel cells. Examples of the various types of electrodes for fuel cells include a membrane electrode assembly (MEA) including a catalyst layer, an electrolyte membrane, and a gas diffusion layer, an electrode membrane (catalyst coated membrane (CCM)) including a catalyst layer and an electrolyte membrane or a gas diffusion electrode (GDE) including a catalyst layer and a gas diffusion layer, and the like.

As shown in FIG. 1, the catalyst ink test system 10 of the embodiment includes, for example, a sample acquisition part 11, an impedance analysis device 12, and a processing device 13.

The sample acquisition part 11 includes, for example, a sample collection device, a measurement electrode cell, and a connection device. For example, the sample collection device collects a test sample from the catalyst ink. The measurement electrode cell includes a housing portion that accommodates the sample collected by the sample collection device, and a pair of electrodes attached to the housing portion. The connection device holds the measurement electrode cell that has accommodated the sample and connects the pair of electrodes of the measurement electrode cell to the impedance analysis device 12.

The impedance analysis device 12 is an inductance-capacitance-resistance (LCR) meter or the like that performs so-called alternating current (AC) impedance measurement and measures the impedance of the sample within the measurement electrode cell. For example, the impedance analysis device 12 applies an AC voltage to the pair of electrodes of the measurement electrode cell by means of a frequency sweep in which the frequency is stepwise varied. Each time the frequency of the applied AC voltage to the sample within the measurement electrode cell is stepwise changed, the impedance analysis device 12 measures the impedance of the sample from a response current flowing through the sample between the pair of electrodes. Based on the impedance measurement data, the impedance analysis device 12 creates a Cole-Cole plot or a Nyquist plot according to a preset equivalent circuit. The preset equivalent circuit is, for example, a resistance-capacitance (RC) parallel circuit including a resistance component R and a capacitance component C or the like.

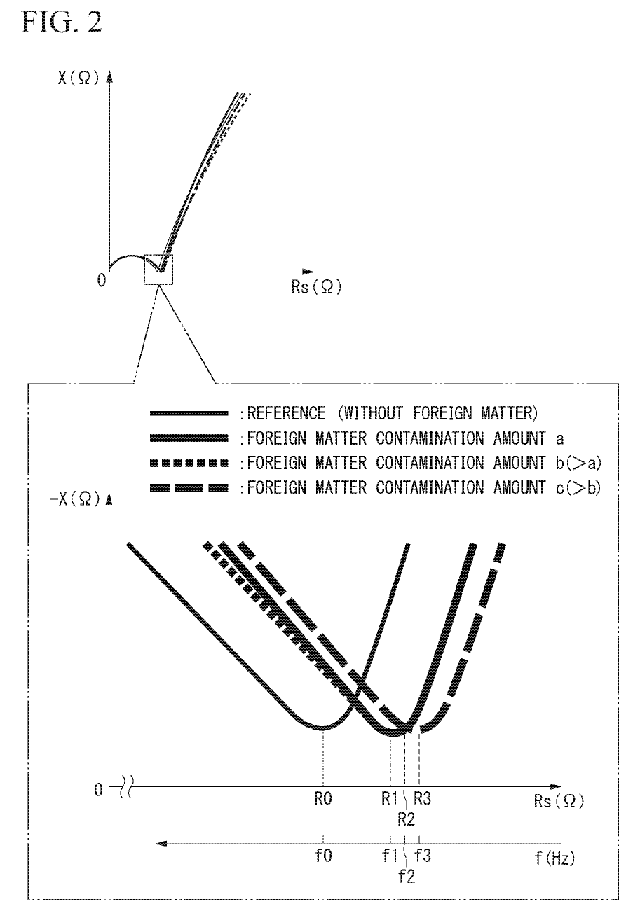

FIG. 2 is a diagram showing an example of a Cole-Cole plot obtained by the catalyst ink test system 10 according to the embodiment.

As shown in FIG. 2, as the amount of foreign matter mixed into the catalyst ink increases, a real component Rs (Ω) of the impedance corresponding to a case where an imaginary component X (Ω) of the impedance is approximately zero changes toward an increasing trend. As the real component Rs (Ω) increases, a resonance frequency f (Hz) corresponding to the real component Rs (Ω) when the imaginary component X (Ω) of the impedance is approximately zero changes toward a decreasing trend. In addition, the foreign matter mixed into the catalyst ink includes, for example, transition metal compounds such as divalent iron compounds originating from the catalyst ink manufacturing device or grinding media.

For example, in the example shown in FIG. 2, compared with an impedance real component R0 and a resonance frequency f0 of the reference catalyst ink without foreign matter contamination, an impedance real component R1 corresponding to a first foreign matter contamination amount a is greater (R1>R0), and a resonance frequency f1 is lower (f1<f0). Compared with the first foreign matter contamination amount a, an impedance real component R2 corresponding to a second foreign matter contamination amount b (>a) greater than the first foreign matter contamination amount a is greater (R2>R1), and a resonance frequency f2 is lower (f2<f1). Compared with the second foreign matter contamination amount b, an impedance real component R3 corresponding to a third foreign matter contamination amount c (>b) greater than the second foreign matter contamination amount b is greater (R3>R2), and a resonance frequency f3 is lower (f3<f2).

The processing device 13, for example, integrally controls the manufacturing process of various types of electrodes for fuel cells according to the embodiment and the operation of the catalyst ink test system 10. For example, the processing device 13 is a software function unit that operates when a predetermined program is executed by a processor such as a central processing unit (CPU). The software function unit is an electronic control unit (ECU) including an electronic circuit such as a processor such as a CPU, a read only memory (ROM) that stores programs, a random-access memory (RAM) that temporarily stores data, and a timer. In addition, at least a part of the processing device 13 may be an integrated circuit such as a large-scale integration (LSI) circuit.

Hereinafter, an operation of the catalyst ink test system 10 of the embodiment will be described.

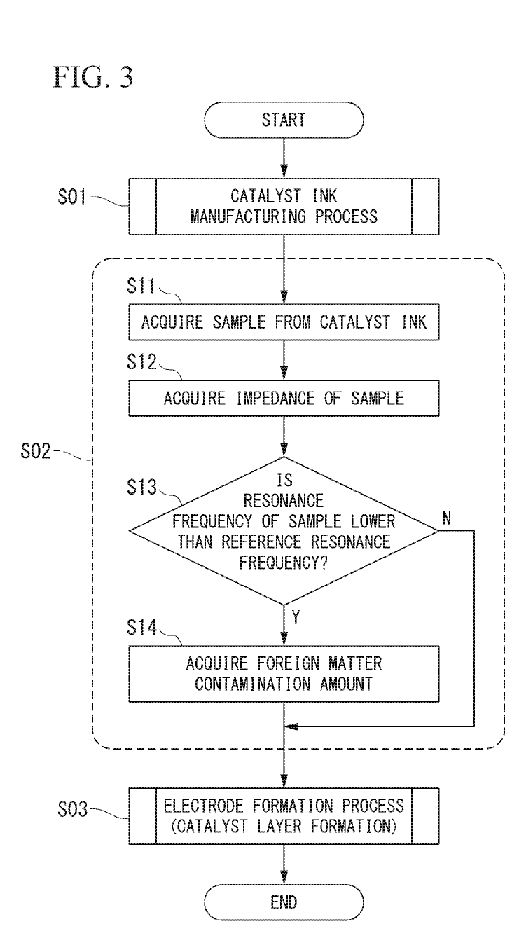

FIG. 3 is a flowchart showing an operation of the catalyst ink test system 10 in the manufacturing process of various types of electrodes for fuel cells according to the embodiment.

As shown in FIG. 3, first, the processing device 13, for example, executes a catalyst ink manufacturing process of a catalyst ink manufacturing device or the like (step S01). The catalyst ink manufacturing process includes, for example, processes such as mixing, dispersing, and grinding of various types of raw materials.

Subsequently, the processing device 13 executes the test of the catalyst ink using the catalyst ink test system 10 (step S02).

Subsequently, the processing device 13 executes a process for forming a catalyst layer and various types of electrodes by coating the catalyst ink using, for example, a catalyst ink coating device (step S03). The processing device 13 forms an electrode having the catalyst layer, for example, by directly coating the catalyst ink onto an electrolyte membrane or a gas diffusion layer, by transfer via coating onto a film substrate, or the like. The processing device 13 may execute the process for forming the catalyst layer and the various types of electrodes using the catalyst ink whose foreign matter contamination amount is less than a predetermined value, in accordance with a result of testing the catalyst ink in step S02. Also, the processing device 13 proceeds to the end of the process.

Hereinafter, the processing of step S02, i.e., the test of the catalyst ink, will be described.

First, the processing device 13 acquires a sample from the catalyst ink by means of the sample acquisition part 11 (step S11).

Subsequently, the processing device 13 measures the impedance of the sample by means of the impedance analysis device 12 (step S12).

Subsequently, the processing device 13 determines whether or not a resonance frequency of the sample is lower than a predetermined reference resonance frequency (step S13). The resonance frequency of the sample is, for example, a frequency corresponding to the real component Rs, when the imaginary component X (Ω) of the impedance is approximately zero, in a Cole-Cole plot or Nyquist plot created by the impedance analysis device 12. The predetermined reference resonance frequency is, for example, the resonance frequency obtained for the reference catalyst ink without foreign matter contamination.

When the determination result is “NO,” the processing device 13 proceeds to step S03. On the other hand, when the determination result is “YES,” the processing device 13 determines that foreign matter is contained in the sample and proceeds to step S14.

Subsequently, based on a difference between the resonance frequency of the sample and the predetermined reference resonance frequency, the processing device 13 acquires an amount of foreign matter mixed into the sample with reference to, for example, a pre-acquired map or the like (step S14). The processing device 13 acquires the amount of foreign matter in the sample, which changes toward an increasing trend, when the resonance frequency of the sample becomes lower than the reference resonance frequency. Also, the processing device 13 proceeds to step S03.

According to the above-described embodiment, the processing device 13 can detect the presence or absence of foreign matter mixed into the catalyst ink in a processing step before the catalyst layer is formed, based on the impedance of the sample. For example, compared with when the presence or absence of foreign matter is detected using a fluorescent X-ray analysis device or an ICP analysis device, it is possible to contribute to speeding up the manufacturing process and reducing costs. It is possible to suppress deterioration in the performance of the fuel cell caused by the foreign matter mixed into the catalyst ink, and to suppress the reduction in the yield when forming the catalyst layer.

Embodiments of the present invention have been presented by way of example only, and are not intended to limit the scope of the inventions. These embodiments may be embodied in a variety of other forms. Various omissions, substitutions, and combinations may be made without departing from the scope of the inventions. The inventions described in the accompanying claims and their equivalents are intended to cover such embodiments or modifications as would fall within the scope of the inventions.

What is claimed is:

1. A catalyst ink test method comprising:
a sample acquisition step of acquiring a test target sample from catalyst ink for forming a catalyst layer laminated on at least one of an electrolyte membrane and a gas diffusion layer;
an impedance acquisition step of acquiring impedance of the sample; and
a processing step of detecting foreign matter mixed into the catalyst ink based on a resonance frequency corresponding to the impedance.

2. The catalyst ink test method according to claim 1, wherein the processing step includes determining that the foreign matter is contained in the catalyst ink when the resonance frequency is less than a predetermined reference value.

3. The catalyst ink test method according to claim 2, wherein the processing step includes determining that an amount of foreign matter contained in the catalyst ink changes toward an increasing trend when the resonance frequency is less than the predetermined reference value.

4. The catalyst ink test method according to claim 2, wherein the predetermined reference value is the resonance frequency of a case where no foreign matter is contained in the catalyst ink.

5. A catalyst ink test system comprising:
a sample acquisition part configured to acquire a test target sample from catalyst ink for forming a catalyst layer laminated on at least one of an electrolyte membrane and a gas diffusion layer;
an impedance acquisition part configured to acquire impedance of the sample; and
a processing unit configured to detect foreign matter mixed into the catalyst ink based on a resonance frequency corresponding to the impedance.
